(19) United States
(12) Patent Application Publication
(10) Pub. No.: US 2004/0143442 A1
(43) Pub. Date: Jul. 22, 2004

(54) Multiple-language audio information transmission system and device

(76) Inventor: Erik A. Knight, The Colony, TX (US)

Correspondence Address: Baker Botts L.L.P., Suite 600, 2001 Ross Avenue, Dallas, TX, 75201-2980, US

(21) Appl. No.: 10/349,550

(22) Filed: Jan. 22, 2003

(51) Int. Cl. G10L 21/00

(52) U.S. Cl. 704/270.1

(57) ABSTRACT

A personal audio device (PAD) includes a communication interface enabling a wireless communication link between the PAD and a communication network. The communication interface is operable to receive an information transmission in a selected language from one or more audio sources coupled to the communication network. Each audio source communicates one or more information transmissions, where the information transmissions pertain to the same subject matter but are in different languages. The PAD also includes a controller operable to process one or more information transmissions received by the communication interface. In addition the PAD includes a user interface operable to receive a selection of a particular language in which a user desires to receive information. The PAD communicates that selection to the controller, the selection indicating to the controller which information transmission to process The PAD also includes an output device operable to provide the contents of the processed information transmission to the user. A system and method allow for a novel communications system directed at providing multiple-language audio information transmissions.

### TECHNICAL FIELD OF THE INVENTION

This invention relates to the field of communications, and more particularly to a multiple-language audio information transmission system and device.

### BACKGROUND OF THE INVENTION

The popularity of international sporting events, such as the Olympics, World Cup soccer, and Formula One auto racing, has given rise to the demand for a device that will allow a spectator at an event to hear the commentary broadcasts of that event in his or her own language. Events often have translations of the official commentary and rulings, but such announcements are usually made one-language-at-a-time over the venue's audio system. Since sporting events move at a rapid pace, there is little time for a full explanation of the commentary and rulings to be given over the venue's public audio system in more than a few languages.

The need to receive information in a language that a person an understand extends beyond sporting events. For example, international travelers may find it necessary to receive information in airports, hotels, or museums in languages that they can understand. Therefore, a need exists to communicate this information to individuals in multiple languages.

### SUMMARY OF THE INVENTION

According to the present invention, a novel system of communicating multiple-language audio information transmissions over a communications network is disclosed. One advantage of the present invention is that a device is provided which allows each spectator the ability to hear the sports broadcasts in a language that they can understand, while requiring only a short-range reception. An efficient method for providing such a system and apparatus is to broadcast the multiple-language information transmissions as streaming packet data over a wireless Local Area Network covering the venue, and to provide spectators with a device that may be “tuned” to receive the information transmissions they desire. Although this system and device are directed toward use at sporting events, they may easily be applied for use anywhere that multiple-language information is required, such as hotels, museums, and airports.

According to one embodiment of the present invention, a personal audio device (PAD) includes a communication interface enabling a wireless communication link between the PAD and a communication network. The communication interface is operable to receive information transmissions in a selected language from one or more audio sources coupled to the communication network. Each audio source communicates one or more information transmissions, where the information transmissions pertain to the same subject matter with each transmission being in a different language. The PAD also includes a controller operable to process one or more information transmissions received by the communication interface. In addition the PAD includes a user interface operable to receive a selection of a particular language in which a user desires to receive information, that selection indicating to the controller which information transmissions to process. The PAD also includes an output device operable to provide the contents of the processed information transmissions to the user.

Embodiments of the present invention may provide one or more of the following important technical advantages. For example, particular embodiments provide a PAD that allows a user to select and receive information transmissions over a communication network in a language that the user can understand. The PAD may also provide various output devices such as speakers or displays, such that the user may hear and/or see the information contained in the transmissions. In addition, the PAD gives the user the ability to program the PAD using various external devices, such as a computer, coupled to the PAD. Other important technical advantages may be readily apparent to those skilled in the art from the figures, description, and claims included herein.

### BRIEF DESCRIPTION OF THE DRAWINGS

To provide a more complete understanding of the present invention and the features and advantages thereof, reference is made to the following description taken in conjunction with the accompanying drawings, in which:

FIG. 1 illustrates an example multiple-language audio information transmission system including a communication network coupled to numerous personal audio devices;

FIG. 2 illustrates example functional components of a personal audio device for receiving multiple-language audio information transmissions; and

FIG. 3 illustrates an example method for communicating multiple-language audio information transmissions.

### DETAILED DESCRIPTION OF THE INVENTION

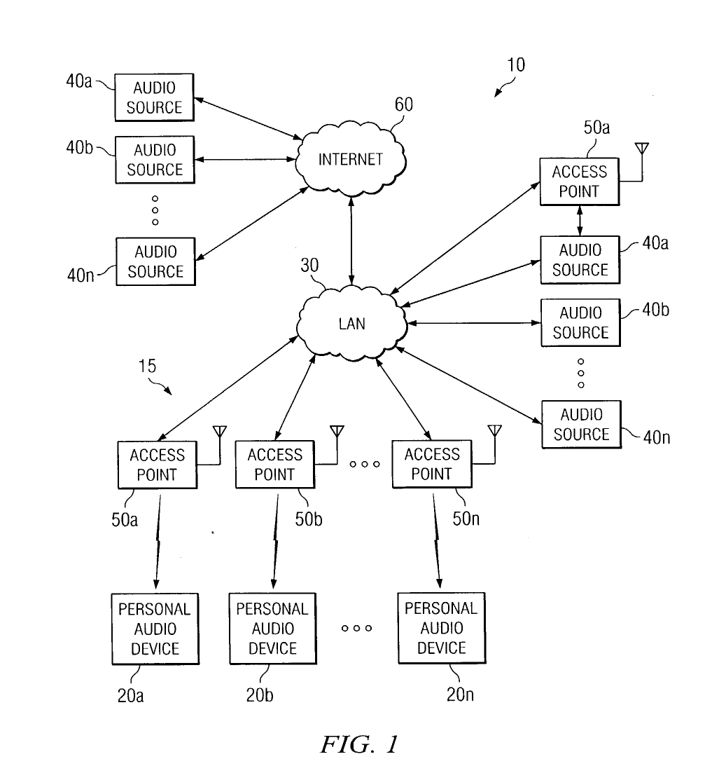

FIG. 1 illustrates an example multiple-language audio information transmission system 10 including at least one personal audio device (PAD) 20 coupled to a communication network 15 using wireless and wireline communication links. Audio sources 40 are also coupled to communication network 15. Audio sources 40 receive multiple-language audio inputs and transmit those inputs to communication network 15 as multiple-language information transmissions. Communication network 15 communicates the audio information transmissions received from audio sources 40 to PADs 20 such that a user of PAD 20 may receive the audio information transmissions from audio source 40. System 10 provides users of PADs 20 an efficient means of receiving multiple-language audio information transmissions in languages that the users can understand.

Communication network 15 may include local area networks (LANs) 30 and Internet 60. LAN 30 may include a wireless local area network (WLAN) and access points 50. In one embodiment, communication network 15 may communicate packetized data streams using the Transmission Control Protocol/Internet Protocol (TCP/IP), the User Datagram Protocol/Internet Protocol (UDP/IP), or any other appropriate packet-based protocol. In a packet-based network utilizing a LAN, the Ethernet protocol, or any other appropriate LAN communication protocol may be implemented. Although use of packet-based networks is described, the present invention is not limited to packet-based communication systems. Other embodiments may include ground-based digital radio networks and/or satellite-based communications networks.

System 10 also includes at least one audio source 40. Audio sources 40 receive analog input in the form multiple-language audio information and communicate that information to PADs 20 over network 15 as multiple-language information transmissions. In an embodiment using IP, audio sources 40 may packetize the input for streaming transmission to PADs 20 over network 15. Audio sources 40 may comprise a computer with the appropriate hardware and software operable to receive and process audio signals. A person or groups of people may provide audio input which is received by a microphone coupled to the computer. For example, the audio input may include real-time commentary of sporting events, information regarding airport and/or hotel procedures, announcements of the closing time of a museum, or any other type of information that a user of PAD 20 would desire to receive. In another embodiment, the audio input may be pre-recorded information which is stored in the memory of audio source 40 until the appropriate transmission time. In yet another embodiment, the information could be input into audio source 40 using a keyboard and audio source 40 would then convert that input into audio using the appropriate hardware and/or software. Any other appropriate techniques for providing the audio input may also be used.

In one embodiment, audio sources 40 may be coupled to LAN 30 by wireline or wireless communication links. In another embodiment, at least one audio source 40 may communicate its associated packet streams to Internet 60 and such audio packet streams are then communicated over Internet 60 to LAN 30. This may be the situation when the audio source is located outside the LAN, such as when audio information for an event in one city is being generated by audio source 40 in another city or country. LAN 30 communicates the audio packet streams to PADs 20 via at least one access point 50. Access points 50 transmit the audio packet streams to PADs 20 over a wireless communications link.

If only one audio source 40 is connected to communications network 15, the commentary, or other information transmission, in each language may be received by that single audio source 40. In another embodiment, a number of audio sources 40 may be coupled to communications network 15 with each audio source dedicated to receiving information in specific languages. For example, audio source 40a may be assigned to receive information in German, Russian, Japanese, and French, while audio source 40b may be assigned to receive information in English, Spanish, and Swedish. In this manner, each audio source may be assigned to receive information in multiple languages. In yet another embodiment, each audio source 40 may be dedicated to receive information in only a single language. For example, audio source 40a may be assigned to receive information in English, audio source 40b may be assigned to receive information in Spanish, and audio source 40c may be assigned to receive information in French. Although particular languages assigned to particular audio sources 40 are illustrated, any appropriate number and combination of audio sources 40 and languages may be included.

PADs 20 are used to receive the multiple-language information transmissions from communication network 15. In certain embodiments, PAD 20 is a wireless communication device carried by the user. If LAN 30 comprises a WLAN, PADs 20 may communicate with the WLAN using a WLAN communication protocol, such as IEEE 802.11, or any other appropriate WLAN protocol. PADs 20 may communicate with LAN 30 or audio sources 40 via access points 50. As described below, each PAD 20 includes appropriate components for enabling such communications.

In one embodiment, system 10 may be located in sports venues, including, but not limited to, indoor arenas, open air stadiums, golf courses, and auto racing circuits. Audio sources 40 may generate audio information regarding the events taking place at these venues. This information may consist of multiple-language information. PADs 20 can be configured by the user to receive the desired language information transmission originating from audio sources 40. In another embodiment, system 10 may be implemented in various other public locations including, but not limited to, airports, hotels, museums, and office buildings. In general, any location where it is desirable to receive information in multiple languages is an appropriate location to provide system 10. For example, in an airport, it is desirable for travelers who may each speak a different language to receive information, such as departure, arrival, and/or customs information, in a language they can understand. As another example, in a hotel, important information regarding check-in/check-out procedures can be transmitted in various languages using system 10. A hotel guest or airport traveler may use a PAD 20 coupled to communication network 15 in order to receive information transmitted in the particular language they desire. Although system 10 is discussed with respect to specific locations, it should be understood that system 10 may be implemented in any appropriate location.

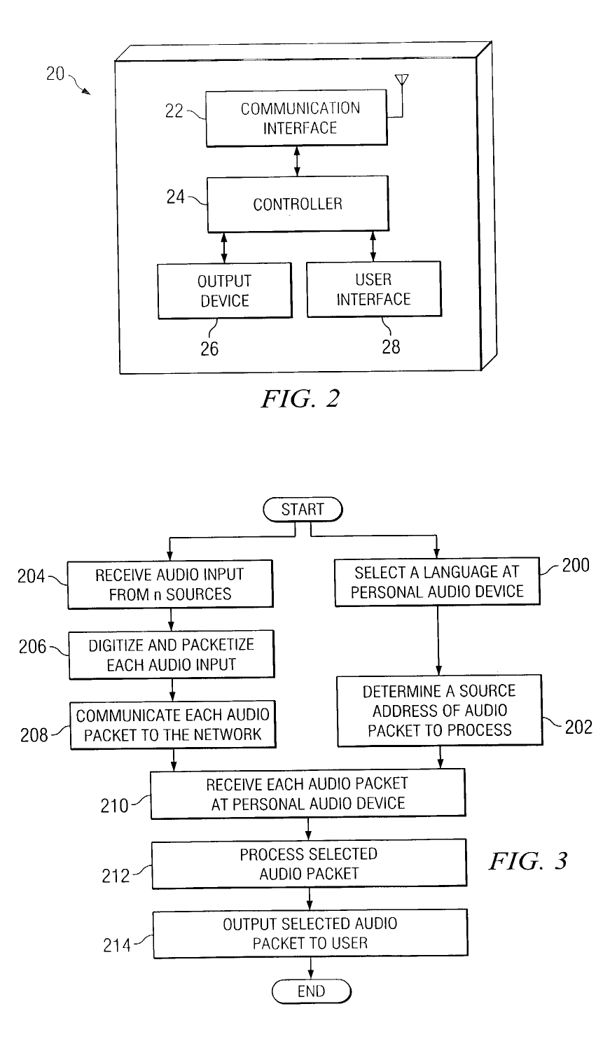

FIG. 2 illustrates example functional components of a PAD 20. Although exemplary components are described below, PAD 20 may also include any other appropriate components. The functional components of PAD 20 may include a communication interface 22 for enabling communication with LAN 30 via access points 50. In general, communication interface 22 supports communication with one or more devices or networks using one or more wireless communication links. As an example only, and not by way of limitation, communication interface 22 may enable communications with a WLAN using the IEEE 802.11 protocol. Communication interface 22 may also be used to communicate with other types of networks, such as ground-based digital radio networks and satellite-based communication networks. Communications interface 22 may be implemented as any suitable combination of hardware and/or software. As an example only, communication interface 22 may include an antenna and a transceiver for receiving and transmitting wireless information (or, in certain embodiments, simply a receiver for receiving wireless information).

PAD 20 also includes a controller 24 for managing the operation of the components comprising PAD 20. For example, controller 24 may execute software to perform specific functions. These functions may include processing information received and/or transmitted by communication interface 22, directing communication interface 22 to connect with the appropriate network, controlling an output device 26, and/or controlling a user interface 28.

In addition, PAD 20 includes output device 26 that outputs information received by communication interface 22 and processed by controller 24. For example, but not by way of limitation, output device 26 could include a speaker, a display, and/or output jacks for earphones or headphones, or any combination of these devices.

Furthermore, PAD 20 includes a user interface 28 that permits a user to adjust various operational characteristics of PAD 20. For example, but not by way of limitation, user interface 28 may include knobs, buttons, and/or switches for adjusting such characteristics as selection of a desired information transmission that the user wishes to receive, a display brightness, and/or an output volume of output device 26. In addition, user interface 28 may permit a user to adjust the frequency reception range based on the region of the world where PAD 20 is being used. For example, in North America, the dedicated frequencies may be in one part of the frequency spectrum, while in Europe, the allocated frequencies may be in a different part of the frequency spectrum.

PAD 20 may include a display comprising, for example, an LCD touch screen with “soft buttons” to replace physical knobs and buttons, as well as an area to display any other appropriate information, such as the language selected by the user, the remaining life of the battery powering PAD 20, the volume level, and the frequency reception range setting. As another example, in addition to the functionality described above, user interface 28 may include a communication port to facilitate the programming of PAD 20 using an external computer or other appropriate programming devices connected to that port.

In one embodiment, the user may select a physical button, knob, or switch associated with a particular information transmission to which the user desires to listen. In this situation, each button, knob, or switch may be associated with a different language setting. In another embodiment, the user may select a given position on a multiple-position button, knob, or switch, where each position corresponds to a different language setting. In yet another embodiment, the user may select “soft-buttons” which may be programmed to correspond to particular language settings.

In one embodiment, each physical button, knob, or switch may contain indicia, such as a numeral or the name of the language, indicating which information transmission is associated with a particular button, knob, or switch. In another embodiment, multiple numerals or the names of multiple languages may be arranged in a pattern proximate to a multiple-position button, knob, or switch so that when a position is selected, an indicia on the button, knob, or switch, such as a pointer, indicates the selected language. In yet another embodiment, a display, such as an LCD, may indicate the selected language. In one embodiment, when communications are established between PAD 20 and communication network 15, the network may transmit data packets containing the associations between the information transmissions and their respective button, knob, or switch positions on user interface 28. When the user selects a given position, the language associated with that position may be provided to the user via a display, such that the user is informed of the selected language. Such a display may be associated with each individual button, switch, or knob. Any other appropriate techniques may also or alternatively be used to select a desired information transmission.

When a desired information transmission is selected through user interface 28, as described above, controller 24 is informed of which incoming information transmission to process. For example, but not by way of limitation, when a given language transmission is selected, controller 24 may determine that incoming streaming data packets, including a particular IP destination address, are to be processed. The allocation of IP destination addresses to given data packets is described below in more detail with respect to step 206 of FIG. 3. Although the use of IP addresses is described, any appropriate form of information identification may be implemented, and packet-based communications need not be used.

FIG. 3 illustrates an example method for communicating multiple-language information transmissions using system 10. The example method begins at step 200 when the user of PAD 20 selects a particular information transmission to receive. The language selection may be made using interface 28, as described above. As an example, but not by way of limitation, the user may select a particular information transmission by selecting a button, switch, or knob corresponding to the language the user desires to receive.

At step 202, controller 24 determines the IP destination address, or other identifying information, of the packets containing the selected information transmission. Controller 24 may determine the IP destination address for a given information transmission in numerous ways. For example, the IP addresses associated with each information transmission may be pre-defined and stored in a memory in each PAD 20. In this situation, an IP address relationship standard may be set such that each language is assigned a given IP address irregardless of the venue in which system 10 is located.

In another embodiment, where the IP address relationships may vary from venue to venue, each audio source 40 coupled to communication network 15 may communicate, to all PADs 20 coupled to the network, data packets containing information on the specific IP addresses associated with particular information transmissions that are being communicated by audio sources 40. Therefore, each PAD 20 connected to network 15 may receive data identifying the IP address of each language transmitted over the network. Software in controller 24 may use this information to create a database of the IP addresses associated with each information transmission. When a user selects a specific information transmission to receive, controller 24 may compare the user's selection with the database of IP addresses to determine which IP destination address is of interest.

In another embodiment, a database containing the relationships between each specific information transmission and its IP destination address may be contained in software in another device, such as a computer, that may be coupled to user interface 28 such that the database is loaded onto PAD 20. In yet another embodiment, a user may program the relationships between a specific information transmission and its associated IP destination address manually into PAD 20 using user interface 28. For example, a spectator at a sporting event may receive an event program which contains a listing of the IP destination addresses associated with the various information transmissions for the particular event. The user may use this data to manually program the relationships into PAD 20 via user interface 28. In certain embodiments, another step may also include communicating the IP address selection to audio sources 40.

At step 204, audio source 40 receives audio input from at least one input source. Audio source 40 may comprise a computer with the appropriate hardware and software operable to receive and process audio input. A person or groups of people may provide real-time audio input in the form of commentary which is received by the microphone coupled to the computer. In another embodiment, the audio input may be pre-recorded information which is stored in the memory of audio source 40 until the appropriate transmission time. In yet another embodiment, the input could be typed into audio source 40 using a keyboard.

At step 206, each analog audio input is digitized and packetized by its associated audio source 40. For example, the appropriate components of audio source 40 may sample the analog audio input at given time intervals. Each sample may then be digitized by an encoder/de-coder and given a “header” to form a digitized packet, as is commonly known in the art. Each packet may be assigned an IP destination address by audio source 40. An IP address is a 32-bit, four-octet value (each octet having eight bits) that is expressed in dotted decimal notation, as is commonly known in the art. In general, the first two octets of the IP address are the network identification and the last two octets are the host identification. However, as is commonly known in the art, the number of octets defining the host and network can vary based on the size of the network. As an example, an IP destination address may have the form “151.10.5.1.” In this example, the first two octets (“151.10”) may identify communication network 15 and the last two octets (“5.1”) may identify a given receiving device (or a given language transmission), as described below.

The IP destination addresses may be assigned in various ways depending upon the method of communication established between communication network 15 and PAD 20. In one embodiment, communication network 15 and PADs 20 engage in one-way communications with PADs 20 receiving data packet streams, but not transmitting data. This may be the case when the particular communications protocol being used does not require the receiving device to send acknowledgements to the transmitting device (or when such a requirement can be designed around, such as by having other network components provide an acknowledgement in place of PADs 20). In this situation, communication network 15 is unable to determine which PADs 20 are connected to the network, because that information is not communicated by PADs 20 to communication network 15. Therefore, audio source 40 is unable to assign an IP destination address to each packet in the data stream based on the IP address of the PAD 20 to receive those packets. In this embodiment, audio source 40 will assign an IP destination address to each streamed packet which is based on the information transmission contained in that packet. For example, but not by way of limitation, all packets in a Spanish language stream may be assigned an IP destination address of 151.10.5.3, all packets in a German language stream may be assigned an IP destination address of 151.10.5.9, and all packets in an English language stream may be assigned an IP destination address of 151.10.5.6. In this manner, each streamed packet in the information transmissions is assigned an IP destination address such that PADs 20 may differentiate one language transmission from a transmission in a different language.

In another embodiment, communication network 15 and PADs 20 engage in two-way communications with communication network 15 and PADs 20 receiving and transmitting data streams. In this situation, communication network 15 may receive data from each PAD 20 coupled to the network informing the network of the particular IP address of each PAD 20 and the particular information transmission that each PAD 20 is to receive. Therefore, audio source 40 may assign an IP destination address to each streamed packet in the desired information transmission based on the IP address of the PAD 20 to receive that information transmission. For example, but not by way of limitation, PAD 20a may have an IP address of 151.10.15.7, PAD 20b may have an IP address of 151.10.20.4, and PAD 20n may have an IP address of 151.10.23.8. In this manner, each packet in the stream comprising the information transmission that PAD 20 is to receive is assigned an IP destination address based on the IP address of each PAD 20 that wishes to receive that information transmission. For example, if PAD 20b is to receive a German information transmission, the German packets in that stream are given an IP destination address of 151.10.20.4 (the IP address of PAD 20b).

Although example IP addresses have been given for PADs 20, any appropriate IP address may be assigned to each PAD 20, such as, for example, an IP address with a first octet of “210,” denoting an IP address which is not routed on the Internet.

After the packets are digitized, packetized, and assigned a destination address, the packets may be combined to form a data stream which is transmitted to the appropriate receiving devices. Although one example is given for digitizing and packetizing the analog audio inputs, the present invention contemplates using any suitable techniques and components for digitizing at packetizing analog audio input signals.

At step 208, audio sources 40 may communicate the streaming audio packets to LAN 30 by wireline or wireless communication links. In another embodiment, at least one audio source 40 may communicate its associated packet streams to Internet 60 and such audio packet streams are then communicated over Internet 60 to LAN 30. This may be the situation when the audio source is located outside the LAN, such as when audio information for an event in one city is being generated by audio source 40 in another city or country. LAN 30 communicates the audio packet streams to PADs 20 via at least one access point 50. Access points 50 transmit the audio packet streams to PADs 20 over a wireless communications link.

In one embodiment of the present invention, a wireless Ethernet LAN 30 is used for communications between audio sources 40 and PADs 20. In the Ethernet context, the Ethernet address of each PAD 20 typically cannot be changed. Therefore, each PAD 20 connected to the network has a fixed Ethernet address in addition to an IP address. In order for each PAD 20 to receive the specific information transmission selected by the user, the transmitting device, in this case audio source 40, identifies the specific IP addresses of all PADs 20 connected to the network which desire to receive the particular information transmission from audio source 40. This can be accomplished by establishing two-way communications between PAD 20 and audio source 40, such as by using the IEEE 802.11 WLAN protocol. For example, PAD 20a may transmit information to all audio sources 40 connected to the network that PAD 20a wishes to receive only German information transmissions and informing audio sources 40 of PAD 20's fixed Ethernet address. In this manner, audio sources 40 may receive information from all PADs 20 connected to the network regarding which Ethernet addresses (i.e., which PADs 20) desire to receive which particular information transmissions. Therefore, audio sources 40 can direct specific information transmissions to specific PADs 20 by addressing each packet in the stream to the specific Ethernet address associated with the appropriate PAD 20.

In another embodiment, PADs 20 do not transmit any information on network 15, but merely receive information. If acknowledgements are required based on the communication protocol in use, other network devices may communicate this acknowledgment in place of an acknowledgement from PADs 20. In this situation, audio sources 40 are unlikely to know the Ethernet addresses of PADs 20 connected to the network or their desired transmissions. Therefore, audio sources 40 cannot communicate specific information transmissions to specific PADs 20. In this case, audio sources 40 may broadcast all information transmissions over the network to an Ethernet broadcast address. As is commonly know, an Ethernet broadcast address is a 48-bit address in which all bits are “1.” All packets in the transmissions sent to the Ethernet broadcast address are received by all PADs 20 coupled to the Ethernet. Therefore, all information transmissions may be transmitted over LAN 30 to an Ethernet broadcast address so that all PADs 20 coupled to the network receive all information transmissions. In this case, IP destination addresses specific to each language are used to allow PADs 20 to discriminate between one language transmission and another. In this manner of operation, PADs 20 can connect and disconnect from the network at-will without the need for audio sources 40 to know which PADs 20 are coupled to the network (so as to know the particular destination addresses).

Although described in a certain sequence above, steps 202 and 204 and 206 and 208 may occur in any appropriate order or simultaneously. For example, the order of these steps may vary or occur simultaneously in a situation where PADs 20 may be continually coupling or de-coupling from the network, causing steps 202, 204, 206, and 208 to occur repeatedly and in no particular order.

At step 210, communication interface 22 receives the audio packet streams communicated by one or more audio sources 40. As discussed in step 202, controller 24 determines the address of the audio packets to be processed by PAD 20 and communicates that address to communication interface 22. In one embodiment, where PADs 20 and communication network 15 have established two-way communications, audio source 40 knows the IP destination address and Ethernet address of each PAD 20. Communication network 15 may transmit the proper information packets to PADs 20 that are to receive them, thus using communication network 15 to stream the proper packets to the proper PADs 20. In another embodiment, where PADs 20 and communication network 15 have established two-way communications, communications network 15 may transmit all information packets as an Ethernet broadcast, thus leaving each PAD 20 with the task of searching through the received packet streams for packets with the particular IP destination address associated with the desired information transmission, as described above.

In another embodiment, such as when communication network 15 and PADs 20 have established only one-way communications and communication network 15 is transmitting using the Ethernet broadcast address, each PAD 20 may receive all information transmissions. As it receives all information transmissions, communication interface 22 searches through all packets in the transmission stream for packets with the IP destination address corresponding to the particular information transmission that the particular PAD 20 is to receive. For example, if PAD 20a is set to a Spanish language transmission, communication interface 22 searches for those packets in the transmission stream with an IP destination address associated with the Spanish language transmission.

In each of the IP embodiments, once communication interface 22 locates the desired packets, communication interface 22 may remove the audio data and communicate that data to controller 24 for processing.

In other embodiments, such as for ground-based digital radio or satellite-based radio, the present invention allows each language to be transmitted on a different frequency. Therefore, the users of PADs 20 do not need to identify an IP address or other packet identifier to receive, in non-packet format, an information transmission in a particular language. Rather, users may tune PADs 20 to the appropriate frequency associated with the desired information transmission.

At step 212, controller 24 processes the data. For example, controller 24 may assemble the data and perform digital signal processing on the data to smooth the data or otherwise correct errors that may appear in the data. Controller 24 may also use an associated codec to convert the data into analog signals that may be output by output device 26. For example, the codec of controller 24 may convert the data in accordance with the desired output settings the user selected through user interface 28. Such output settings may include volume level, treble level, bass level, and/or any other appropriate output parameter. The signals are then communicated to output device 26.

At step 214, the processed data is output to the user through output interface 26, and the method ends. Output interface 26 could include a speaker, a display, and/or an output jack for earphones or headphones, or any combination of these or similar devices.

Although an exemplary method is illustrated, the present invention contemplates using any suitable techniques and components for transmitting multiple-language information transmissions between a local area network and a PAD 20. For example, many of the steps in FIG. 3 may be performed by components other than those described and illustrated. Moreover, many of the steps in FIG. 3 may take place simultaneously and/or in different orders than as shown. In addition, the present invention contemplates using methods with additional steps, fewer steps, or different steps, so long as the methods remain appropriate for transmitting multiple-language audio information transmissions between a local area network and PAD 20. Furthermore, although packet-based communications are described, other communications techniques may also be used.

Although the present invention has been described with several embodiments, numerous changes, substitutions, variations, alterations, and modifications may be suggested to one skilled in the art, and it is intended that the invention encompass all such changes, substitutions, variations, alterations, and modifications as fall within the spirit and scope of the appended claims.

What is claimed is:

1. A personal audio device, comprising:
a communication interface enabling a wireless communication link between the personal audio device and a communication network, the communication interface operable to receive an information transmission in a selected language from one or more audio sources coupled to the communication network, wherein each audio source communicates one or more information transmissions, and wherein the information transmissions pertain to the same subject matter but are in different languages;
a controller operable to process an information transmission received by the communication interface;
a user interface operable to receive a selection of a particular language in which a user desires to receive information and to communicate the selection to the controller, the selection indicating to the controller which information transmission to process; and
an output device operable to provide the contents of the processed information transmission to the user.

2. The personal audio device of claim 1, wherein the information transmissions comprise streams of audio data packets.

3. The personal audio device of claim 2, wherein the communication network comprises a wireless local area network including one or more wireless access points.

4. The personal audio device of claim 2, wherein the communications interface is operable to identify data packets to communicate to the controller for processing based on an Internet Protocol (IP) destination address of those packets.

5. The personal audio device of claim 4, wherein the IP destination address is associated with the language of the information transmission contained in the packet stream.

6. The personal audio device of claim 4, wherein the IP destination address is associated with the personal audio device.

7. The personal audio device of claim 1, wherein the communication interface is further operable to transmit data to one or more of the audio sources to indicate an information transmission the user desires to receive.

8. The personal audio device of claim 1, wherein the user interface comprises buttons that are each associated with a particular language, wherein the selection of a particular button by the user indicates to the controller a particular information transmission to be received.

9. A system for providing multiple-language audio information transmissions, comprising:
one or more audio sources each operable to receive one or more information inputs, wherein the information inputs pertain to the same subject matter but are in different languages, the information inputs being communicated by the audio source as information transmissions;
a communication network operable to receive and transmit the information transmissions; and
one or more personal audio devices operable to receive a selected information transmission, wherein the audio device comprises:
a communication interface enabling a wireless communication link between the personal audio device and the communication network, the communications interface operable to receive information transmissions;
a controller operable to process an information transmission received by the communication interface;
a user interface operable to receive a selection of a particular language in which a user desires to receive information and to communicate the selection to the controller, the selection indicating to the controller which information transmission to process; and
an output device operable to provide the contents of the processed information transmission to the user.

10. The system of claim 9, wherein the one or more audio sources receive information inputs relating to live events and communicate those inputs as information transmissions on a real-time basis.

11. The system of claim 9, wherein the audio sources are further operable to digitize and packetize an information input into an information transmission that comprises a stream of audio data packets.

12. The system of claim 11, wherein the communication network comprises a wireless local area network including one or more wireless access points.

13. The system of claim 11, wherein the communication interface of the personal audio device is operable to identify data packets to communicate to the controller for processing based on an Internet Protocol (IP) destination address of those packets.

14. The system of claim 13, wherein the IP destination address is associated with the language of the information transmission contained in the packet stream.

15. The system of claim 13, wherein the IP destination address is associated with the specific personal audio device.

16. The system of claim 9, wherein the communication interface of the personal audio device is further operable to transmit data to one or more of the audio sources to indicate an information transmission the user desires to receive.

17. The system of claim 9, wherein the user interface of the personal audio device comprises buttons that are each associated with a particular language, wherein the selection of a particular button by the user indicates to the controller a particular information transmission to be received.

18. A method for providing multiple-language audio information transmissions, comprising:
receiving one or more information inputs at one or more audio sources, the information input pertaining to the same subject matter with each input being in a different language;
communicating the one or more information inputs received by the one or more audio sources as information transmissions to a communication network, wherein the communication network is operable to receive and transmit the information transmissions;
communicating the information transmissions received by the communication network to one or more personal audio devices operable to receive a selected information transmission, wherein the audio device comprises:
a communication interface enabling a wireless communication link between the personal audio device and the communication network, the communications interface operable to receive information transmissions;
a controller operable to process an information transmission received by the communication interface;
a user interface operable to receive a selection of a particular language in which a user desires to receive information and to communicate the selection to the controller, the selection indicating to the controller which information transmission to process; and
an output device operable to provide the contents of the processed information transmission to the user.

19. The method of claim 18, wherein the one or more audio sources receive information inputs relating to live events and communicate those inputs as information transmissions on a real-time basis.

20. The method of claim 18, wherein the information transmissions comprise streams of audio data packets.

21. The method of claim 20, wherein the communication network comprises a wireless local area network including one or more wireless access points.

22. The method of claim 18, wherein the personal audio device is further operable to transmit data to one or more of the audio sources to indicate the information transmission the user desires to receive.

23. The method of claim 18, wherein the personal audio device comprises buttons that are each associated with a particular language, wherein the selection of a particular button by the user indicates to the controller of the personal audio device a particular information transmission to be received.
